(19) United States
(12) Patent Application Publication
(10) Pub. No.: US 2026/0096541 A1
(43) Pub. Date: Apr. 9, 2026

(54) SELF-ADAPTIVE TENSIONING WEARABLE MONITORING DEVICE FOR POULTRY AND LIVESTOCK

(71) Applicant: ZHEJIANG UNIVERSITY, Hangzhou (CN)

(72) Inventors: Jinming PAN, Hangzhou (CN); Haixiang XU, Hangzhou (CN); Hongjian LIN, Hangzhou (CN); Pengguang HE, Hangzhou (CN); Zunzhong YE, Hangzhou (CN); Yibin YING, Hangzhou (CN); Jintian CHEN, Hangzhou (CN); Binbo XU, Hangzhou (CN); Shupeng HE, Hangzhou (CN); Mengzui DI, Hangzhou (CN); Shaomin XU, Hangzhou (CN); Yefan HE, Hangzhou (CN)

(73) Assignee: ZHEJIANG UNIVERSITY, Hangzhou (CN)

(21) Appl. No.: 19/417,420

(22) Filed: Dec. 12, 2025

Related U.S. Application Data
(63) Continuation of application No. PCT/CN2024/144349, filed on Dec. 31, 2024.

(30) Foreign Application Priority Data
Jan. 23, 2024 (CN) 202410091738.7

(51) Int. Cl. A01K 29/00; G01K 1/143; G01K 13/20

(52) U.S. Cl. CPC A01K 29/005; G01K 1/143; G01K 13/20

(57) ABSTRACT

The provided is a self-adaptive tensioning wearable monitoring device for poultry and livestock, where a flexible loop band is threaded through a self-adaptive tensioning module and a monitoring module, and is connected end-to-end inside the self-adaptive tensioning module; a surface of the monitoring module is provided with a wireless sensing module; the monitoring module is slidably connected to the flexible loop band; the self-adaptive tensioning module includes one end fixedly connected to a fixed end of the flexible loop band and the other end telescopically connected to a movable end of the flexible loop band; the self-adaptive tensioning module is disposed at a poultry/livestock back; and when the flexible loop band is tightened, the wireless sensing module at the surface of the monitoring module is in close contact with a skin in a poultry/livestock body temperature measurement area.

### CROSS-REFERENCE TO THE RELATED APPLICATIONS

This application is a continuation application of International Application No. PCT/CN2024/144349, filed on Dec. 31, 2024, which is based upon and claims priority to Chinese Patent Application No. 202410091738.7, filed on Jan. 23, 2024, the entire contents of which are incorporated herein by reference.

### TECHNICAL FIELD

The present disclosure relates to the field of intelligent perception of poultry and livestock information, and specifically to a self-adaptive tensioning wearable monitoring device for poultry and livestock.

### BACKGROUND

With ongoing technological advancement, intelligent, information-driven, and precision farming has become the prevailing trend in the poultry and livestock farming industry. During large-scale operations, equipping a subset of poultry and livestock with intelligent monitoring devices enables population-level data acquisition. Compared to manual methods, wireless intelligent monitoring devices offer advantages such as small size, high precision, and low stress.

Physiological data such as body temperature and electrodermal response of poultry and livestock serves as an important health status indicator of poultry and livestock. Timely detection of abnormalities in such physiological data is of great significance for reducing medication usage on farms, preventing large-scale disease outbreaks, and tracing health indicator data throughout the production chain of poultry and livestock products. Regarding the body temperature information of poultry and livestock, in current farming practices, the cloacal temperature is usually manually measured as the core body temperature, but the measurement process causes significant stress to the poultry and livestock. Chinese patent application CN112914518A proposes underwing body temperature, which exhibits a strong correlation with core body temperature. The ratio between the underwing axillary region temperature and the cloacal temperature is approximately 0.983. Therefore, chicken health can be monitored by measuring the axillary temperature of chickens.

Current body temperature monitoring technologies for chickens mostly utilize thermal imaging cameras. For example, Chinese patent applications CN114115403A and CN112005931A employ non-contact temperature measurement with minimal stress, but they suffer from low accuracy and high practical costs, resulting in limited effectiveness in actual production. Chinese patent applications CN114970755A and CN115219050A employ a direct-contact body temperature monitoring technology using sensors in direct contact with the underwing skin, offering high accuracy and valuable data reference. However, the sensors are difficult to put on chickens for extended periods in practical use and lack specialized wearable structural designs for chickens. Consequently, these sensors cause significant stress and yield poor practical results. Particularly for fast-growing white-feathered broilers, which dominate the largest market share, the rapid increase in their body size makes it challenging to ensure stable sensor wearing and temperature measurement. Therefore, designing a conveniently wearable monitoring device for various physiological indicators of poultry and livestock is of great significance.

### SUMMARY

To solve the problems in the background technology, the present disclosure provides a self-adaptive tensioning wearable monitoring device for poultry and livestock. The present disclosure designs a self-adaptive tensioning module that can adaptively adjust the device size with the growth of poultry and livestock. Thus, the present disclosure solves the problem of poultry and livestock being unable to wear wearable devices for long periods in production, improving the stability and accuracy of monitoring various physiological indicators of poultry and livestock.

The present disclosure adopts the following technical solution.

The device of the present disclosure includes a self-adaptive tensioning module, a wireless sensing module, a flexible loop band, and a monitoring module, wherein the flexible loop band is threaded through the self-adaptive tensioning module and the monitoring module, and is connected end-to-end inside the self-adaptive tensioning module; a surface of the monitoring module is provided with the wireless sensing module; the monitoring module is slidably connected to the flexible loop band; the self-adaptive tensioning module includes one end fixedly connected to a fixed end of the flexible loop band and the other end telescopically connected to a movable end of the flexible loop band; the self-adaptive tensioning module is disposed at a poultry/livestock back; and when the flexible loop band is tightened, the wireless sensing module at the surface of the monitoring module is in close contact with a skin in a poultry/livestock axillary region.

The self-adaptive tensioning module includes a tensioner, a rotating core, and a spiral spring; the tensioner is internally provided with a cylindrical cavity; the cylindrical cavity is provided with a cylindrical shaft along an axial direction; two end faces of the cylindrical shaft abut against an inner wall of the tensioner; the cylindrical shaft includes one end provided with the spiral spring and the other end passing through a central through hole of the rotating core sleeved on the cylindrical shaft; an outer circumferential surface of the rotating core is provided with a first clamping slot and a loop band clamping slot; the cylindrical shaft is provided with a cylindrical cavity along a vertical direction; and the spiral spring includes an inner end fixed inside the cylindrical cavity and an outer end fixed in the first clamping slot in the outer circumferential surface of the rotating core; and

two ends of the tensioner are respectively provided with through holes; the fixed end of the flexible loop band passes through the through hole at one end of the tensioner to enter the tensioner, and is fixed inside the tensioner; the movable end of the flexible loop band passes through the through hole at the other end of the tensioner to enter the tensioner, winds around the outer circumferential surface of the rotating core, and is fixedly embedded into the loop band clamping slot; the movable end retracts or extends as the rotating core rotates; the rotating core is connected to the tensioner via the spiral spring of appropriate hardness; as a poultry/livestock chest circumference grows, the flexible loop band extends; the rotating core rotates clockwise, storing energy in the spiral spring, which generates a counteracting tension force, ensuring the soft conforming pad tightly conforms to the poultry/livestock back; a curvature of a conforming part mimics a contour curve of the poultry/livestock back, resembling a physiological contour line, thereby reducing discomfort caused by long-term pressure on a skin of the poultry/livestock back; the fixed end and the movable end of the flexible loop band are respectively provided with fixing buckles; the fixed end of the flexible loop band is buckled onto a fixed post inside the tensioner via the fixing buckle; and the movable end of the flexible loop band is embedded into the loop band clamping slot via the fixing buckle.

A diameter of the cylindrical cavity is greater than an outer diameter of the rotating core, and a diameter of the cylindrical shaft is less than a diameter of the central through hole of the rotating core.

The monitoring module includes a connection module and a patch; two ends of the connection module are respectively provided with loop band through holes; the flexible loop band passes through the loop band through holes; surfaces of the flexible loop band at two sides of the connection module are provided with limit protrusions, respectively; the patch is fixed to an end face of the connection module close to the skin in the poultry/livestock axillary region; a surface of the patch is provided with a bionic octopus sucker array; and the surface of the patch is provided with a circular groove for holding the wireless sensing module.

the wireless sensing module includes a sensing chip layer, an antenna layer, a power layer, and a flexible printed circuit (FPC); the wireless sensing module sequentially includes the sensing chip layer, the power layer, and the antenna layer; the antenna layer is attached to a bottom surface of the circular groove; the FPC is connected to the sensing chip layer and the antenna layer; and the sensing chip layer is in close contact with the skin in the poultry/livestock axillary region as a poultry/livestock body temperature measurement area.

The device further includes a soft conforming pad; the soft conforming pad includes an arc-shaped plate structure; an outer curved surface of the soft conforming pad conforms to an inner curved surface of the tensioner; and the soft conforming pad extends axially and conforms to the poultry/livestock back.

The bionic octopus sucker array is made of silicone rubber; and when the flexible loop band is tightened, a compressive force is applied to the bionic octopus sucker array, thereby causing deformation.

The bionic octopus sucker array includes cylindrical concave cavities formed by a combination of a cylindrical hole array mold and a metal ball.

The wireless sensing module is an electronic device for monitoring a body temperature or an electrodermal response.

The present disclosure ensures the basic functions of contact-based accurate monitoring and wireless transmission through the wireless sensing module. The present disclosure can monitor body signals of poultry and livestock such as body temperature and electrodermal response, and employs an innovatively designed adaptive tensioning mechanism. Compared to other wearable technologies, the present disclosure features adaptive size adjustment and automatic tensioning. Therefore, the present disclosure eliminates the inconvenience of periodical manual loosening required by conventional wearable monitoring bands. The bionic octopus sucker array on the patch prevents issues such as the monitoring site floating or detaching caused by disturbances from significant livestock movements, poultry flapping, or feather pecking during long-term wear. Thus, the present disclosure improves the stability and accuracy of monitoring various physiological indicators.

Compared with the prior art, the present disclosure has the following beneficial effects:
1. The device of the present disclosure ensures the basic functions of contact-based accurate monitoring and wireless transmission. Compared to other existing non-contact monitoring technologies, the present disclosure offers higher precision, smaller size, lower cost, and more convenient usage.
2. The device of the present disclosure adopts an innovatively designed adaptive tensioning mechanism. Compared to other wearable technologies, it features adaptive size adjustment and automatic tensioning. Therefore, the present disclosure eliminates the inconvenience of periodical manual loosening required by conventional wearable monitoring bands, meets the need for ultra-long-term wear, and significantly enhances practicality.
3. The device of the present disclosure employs an innovatively designed multi-point bionic structure. The soft silicone conforming pad covering the tensioner on the back mimics the physiological curve of the poultry/livestock back, reducing discomfort from long-term pressure. The bionic octopus sucker array on the patch prevents issues such as the monitoring site floating or detaching caused by disturbances from significant livestock movements, poultry flapping, or feather pecking during long-term wear. Thus, the present disclosure improves the stability and accuracy of monitoring various physiological indicators.

### BRIEF DESCRIPTION OF THE DRAWINGS

FIG. 1 is an overall structural view of the present disclosure;

FIG. 2 is a close-up view of a patch area;

FIG. 3 is a schematic diagram of a wireless sensing module;

FIG. 4 is a schematic diagram of a flexible loop band assembled inside a tensioner; and

FIG. 5 is a graph showing a body temperature monitoring result of a chicken among poultry using the monitoring device.

Reference Numerals: 1. self-adaptive tensioning module; 2. fixed end; 3. soft conforming pad; 4. patch; 5. connection module; 6. wireless sensing module; 7. sensing chip layer; 8. bionic octopus sucker array; 9. loop band through hole; 10. tensioner; 11. through hole; 12. movable end; 13. flexible loop band; 14. limit protrusion; 15. antenna layer; 16. power layer; 17. cylindrical cavity; 18. cylindrical cavity; 19. cylindrical shaft; 20. rotating core; 21. first clamping slot; 22. loop band clamping slot; 23. spiral spring; 24. fixed post; and 25. flexible printed circuit (FPC).

### DETAILED DESCRIPTION OF THE EMBODIMENTS

The present disclosure will be further described below in conjunction with the drawings and embodiments.

The embodiments of the present disclosure are described as follows.

### Embodiment 1

In this embodiment of the present disclosure, a monitoring device is used to monitor a body temperature of a chicken among poultry.

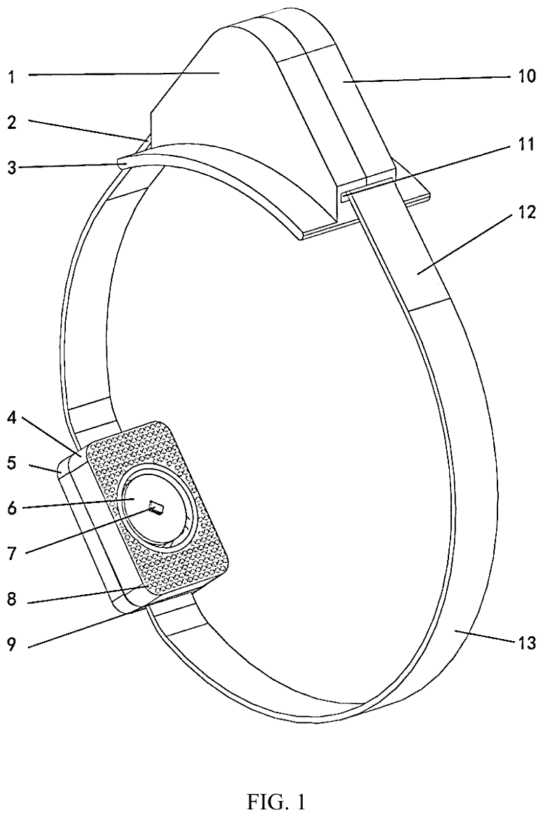

As shown in FIG. 1, the device includes self-adaptive tensioning module 1, wireless sensing module 6, flexible loop band 13, and a monitoring module. The flexible loop band 13 is threaded through the self-adaptive tensioning module 1 and the monitoring module, and is connected end-to-end inside the self-adaptive tensioning module 1. A surface of the monitoring module is provided with the wireless sensing module 6. The wireless sensing module 6 is an electronic device. The monitoring module is slidably connected to the flexible loop band 13. One end of the self-adaptive tensioning module 1 is fixedly connected to fixed end 2 of the flexible loop band 13, and the other end of the self-adaptive tensioning module 1 is telescopically connected to movable end 12 of the flexible loop band 13. The movable end 12 can freely extend and retract under the action of tensioner 10 inside the self-adaptive tensioning module 1. When the flexible loop band 13 is tightened, the wireless sensing module 6 is in close contact with a skin at a chicken's wing. The flexible loop band 13 is made of flexible skin-friendly nylon, which is non-elastic and non-stretchable, causing minimal skin irritation.

The self-adaptive tensioning module 1 includes the tensioner 10, rotating core 20, and spiral spring 23.

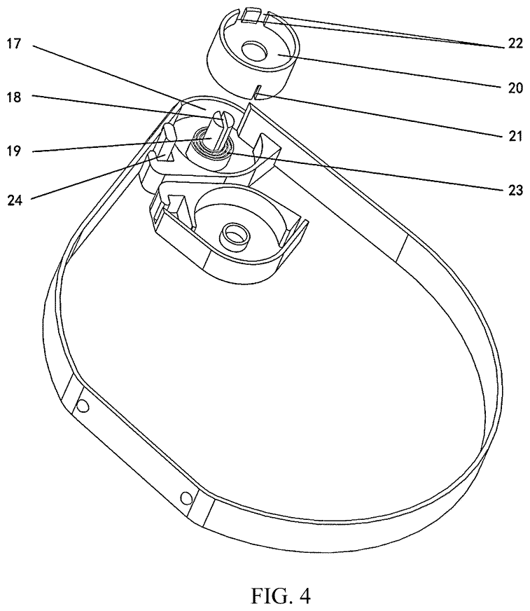

As shown in FIG. 4, the tensioner 10 is internally provided with cylindrical cavity 17. The cylindrical cavity 17 is provided with cylindrical shaft 19 along an axial direction. Two end faces of the cylindrical shaft 19 abut against an inner wall of the tensioner 10. One end of the cylindrical shaft 19 is provided with the spiral spring 23, and the other end of the cylindrical shaft 19 passes through a central through hole of the rotating core 20 sleeved on the cylindrical shaft 19. An outer circumferential surface of the rotating core 20 is provided with first clamping slot 21 and loop band clamping slot 22. The cylindrical shaft 19 is provided with cylindrical cavity 18 along a vertical direction. An inner end of the spiral spring 23 is fixed inside the cylindrical cavity 18, and an outer end of the spiral spring 23 is fixed in the first clamping slot 21 in the outer circumferential surface of the rotating core 20. A diameter of the cylindrical cavity 17 is greater than an outer diameter of the rotating core 20, and a diameter of the cylindrical shaft 19 is less than a diameter of the central through hole of the rotating core 20.

The device further includes soft conforming pad 3. The soft conforming pad 3 includes an arc-shaped plate structure. The tensioner 10 and the soft conforming pad 3 form an integrated structure. An outer curved surface of the soft conforming pad 3 conforms to an inner curved surface of the tensioner 10. The tensioner 10 is wrapped by the soft conforming pad 3. The soft conforming pad 3 extends axially and conforms to the chicken's back, and it is dustproof and waterproof.

Two ends of the tensioner 10 are respectively provided with through holes 11. The fixed end 2 of the flexible loop band 13 passes through the through hole 11 at one end of the tensioner 10 to enter the tensioner 10, and is fixed inside the tensioner 10.

The movable end 12 of the flexible loop band 13 passes through the through hole 11 at the other end of the tensioner 10 to enter the tensioner 10, winds around the outer circumferential surface of the rotating core 20, and is fixedly embedded into the loop band clamping slot 22. The movable end 12 retracts or extends as the rotating core 20 rotates. The rotating core 20 is connected to the tensioner 10 via the spiral spring 23 of appropriate hardness. As the chicken's chest circumference grows, the flexible loop band 13 extends. The rotating core 20 rotates clockwise, storing energy in the spiral spring 23, which generates a counteracting tension force, ensuring the soft conforming pad 3 tightly conforms to the chicken's back. The curvature of the conforming part mimics the contour curve of the chicken's back, resembling the physiological contour line of the chicken, thereby reducing discomfort caused by long-term pressure on the back skin.

The spiral spring 23 of the self-adaptive tensioning module 1 is a constant-force coil spring, where the stress generated during normal deformation remains substantially constant, and the spring hardness ensures secure tensioning without harming the skin.

The fixed end 2 and the movable end 12 of the flexible loop band 13 are respectively provided with fixing buckles. The fixed end 2 of the flexible loop band 13 is buckled onto fixed post 24 inside the tensioner 10 via the fixing buckle. The movable end 12 of the flexible loop band 13 is embedded into the loop band clamping slot 22 via the fixing buckle.

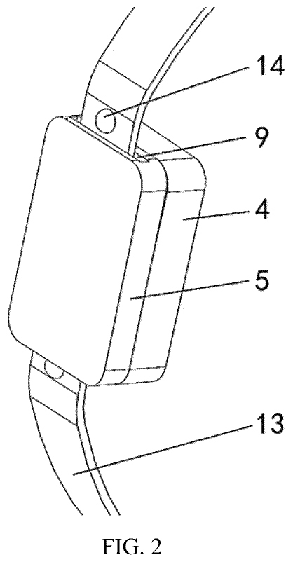

As shown in FIG. 2, the monitoring module includes connection module 5 and patch 4. Two ends of the connection module 5 are respectively provided with loop band through holes 9. The flexible loop band 13 passes through the loop band through holes 9. Surfaces of the flexible loop band 13 at two sides of the connection module 5 are provided with limit protrusions 14, respectively. The patch 4 is fixed to an end face of the connection module 5 close to a chicken wing skin. A surface of the patch 4 is provided with bionic octopus sucker array 8. The bionic octopus sucker array 8 is made of two-component silicone rubber of moderate hardness, possessing certain flexibility and shape retention. Compared to a flat surface, the physical adhesion generated by the bionic octopus sucker array 8 allows for tighter attachment to the monitoring site and more accurate monitoring results. The bionic octopus sucker array 8 is prepared using a special mold. Under the tension force generated by the tensioner 10, the bionic octopus sucker array is pressed against the skin surface, expelling air from the cavities of the suckers. The negative pressure effect enhances stable adhesion and friction with the skin, preventing phenomena like the monitoring site floating or detaching from the skin surface due to disturbances caused by chicken movements, flapping, or feather pecking during monitoring.

The connection module 5 cooperating with the flexible loop band 13 is encapsulated in a lightweight hard shell. As the chicken's chest circumference increases, the flexible loop band 13 is stretched. The sliding cooperation area between the flexible loop band 13 and the connection module 5 is provided with the limit protrusions 14. The limit protrusions 14 slightly protrude from the plane of the flexible loop band 13, preventing the connection module 5 from exceeding the optimal range of sliding adjustment.

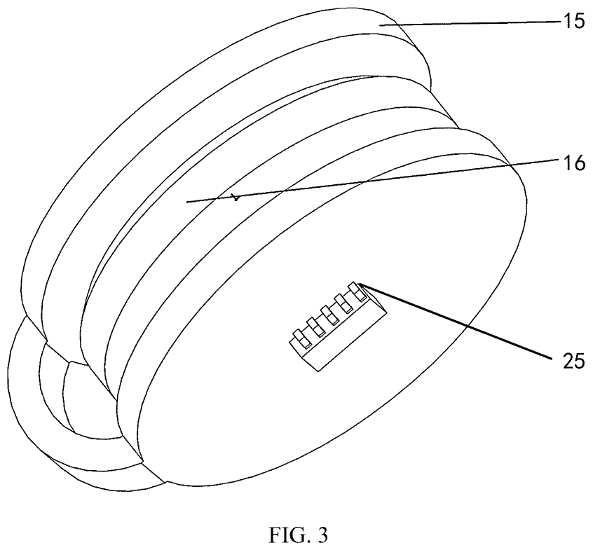

As shown in FIG. 3, the surface of the patch 4 is provided with a circular groove, and the wireless sensing module 6 is provided in the circular groove.

The wireless sensing module 6 includes sensing chip layer 7, antenna layer 15, power layer 16, and flexible printed circuit (FPC) 25. The wireless sensing module 6 sequentially includes the sensing chip layer 7, the power layer 16, and the antenna layer 15. The antenna layer 15 is attached to a bottom surface of the circular groove. The FPC 25 is connected to the sensing chip layer 7 and the antenna layer 15. The patch 4 is attached to a featherless skin area of the axillary region under the chicken's wing. The attached bionic sucker array 8 generates physical adhesion under tension, holding the patch 4 firmly against the skin surface. The sensing chip layer 7 is in close contact with the skin at the chicken's wing. The wireless sensing module 6 monitors the skin temperature at the chicken's wing at a certain frequency and transmits it wirelessly to a host computer, achieving the temperature measurement function. As the chicken grows and its chest circumference gradually expands, the reserved loop band of the movable end 12 wound on the rotating core 20 is gradually pulled out to achieve self-adaptation to the chest circumference. The patch 4 is disposed on one side of the loop band fixed end 2. Its position is relatively stable, minimally affected by the overall increase in the loop band length, which is conducive to stable temperature measurement.

During daily chicken activities such as movement, flapping, and feather pecking, the patch 4 is slidably connected to the flexible loop band 13. The sliding of the patch 4 on the loop band buffers disturbances along the loop band direction, maintaining stable contact between the sensing chip layer 7 and the skin.

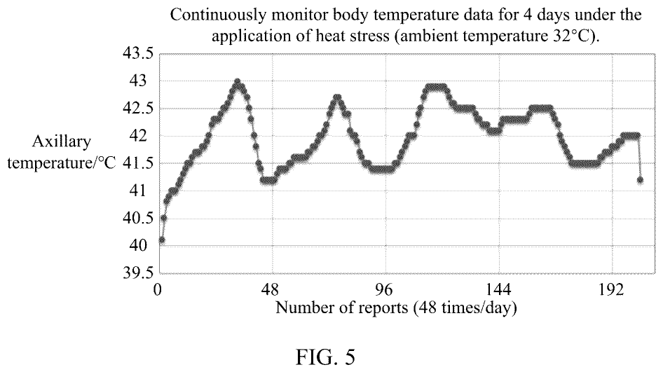

The ratio between the underwing axillary region temperature and the cloacal temperature in poultry is approximately 0.983. In this embodiment, the wireless sensing module 6 is an electronic device for temperature measurement, applied to white-feathered broilers. The wireless sensing module 6 monitors the skin temperature (i.e., body temperature) of the underwing axillary region of white-feathered broilers at a certain frequency. The device is worn on white-feathered broilers approximately one week after vaccination and can be worn long-term until slaughter. During this period, no manual loosening or adjustment is required, and body temperature data is transmitted wirelessly to the host computer and cloud. As shown in FIG. 5, the monitoring device is used for continuous body temperature monitoring of a white-feathered broiler for 4 days, with body temperature data uploaded every 30 minutes via the wireless sensing module 6. This enables timely detection of abnormalities in body temperature and other physiological data of poultry and livestock, which is of great significance for reducing medication usage on farms, preventing large-scale disease outbreaks, and tracing health indicator data throughout the production chain of poultry and livestock products. Overall, the present disclosure employs a more accurate monitoring method involving direct contact with the skin in the axillary region of poultry and livestock, utilizes a specially designed wearable structure, and innovatively designs a tensioning structure adaptive to chest circumference and a stable patch-type structure. In this way, the present disclosure solves the difficulties in applying current wearable monitoring technologies in the poultry farming field.

### Embodiment 2

In this embodiment of the present disclosure, a monitoring device is used to perform electrodermal monitoring on a cattle among livestock.

As shown in FIG. 1, the device includes self-adaptive tensioning module 1, wireless sensing module 6, flexible loop band 13, and a monitoring module. The flexible loop band 13 is threaded through the self-adaptive tensioning module 1 and the monitoring module, and is connected end-to-end inside the self-adaptive tensioning module 1. A surface of the monitoring module is provided with the wireless sensing module 6. The wireless sensing module 6 is an electronic device. The monitoring module is slidably connected to the flexible loop band 13. One end of the self-adaptive tensioning module 1 is fixedly connected to fixed end 2 of the flexible loop band 13, and the other end of the self-adaptive tensioning module 1 is telescopically connected to movable end 12 of the flexible loop band 13. The movable end 12 can freely extend and retract under the action of tensioner 10 inside the self-adaptive tensioning module 1. When the flexible loop band 13 is tightened, the wireless sensing module 6 is in close contact with a skin at a cattle's chest. The flexible loop band 13 is made of flexible skin-friendly nylon, which is non-elastic and non-stretchable, causing minimal skin irritation.

The self-adaptive tensioning module 1 includes the tensioner 10, rotating core 20, and spiral spring 23.

As shown in FIG. 4, the tensioner 10 is internally provided with cylindrical cavity 17. The cylindrical cavity 17 is provided with cylindrical shaft 19 along an axial direction. Two end faces of the cylindrical shaft 19 abut against an inner wall of the tensioner 10. One end of the cylindrical shaft 19 is provided with the spiral spring 23, and the other end of the cylindrical shaft 19 passes through a central through hole of the rotating core 20 sleeved on the cylindrical shaft 19. An outer circumferential surface of the rotating core 20 is provided with first clamping slot 21 and loop band clamping slot 22. The cylindrical shaft 19 is provided with cylindrical cavity 18 along a vertical direction. An inner end of the spiral spring 23 is fixed inside the cylindrical cavity 18, and an outer end of the spiral spring 23 is fixed in the first clamping slot 21 in the outer circumferential surface of the rotating core 20. A diameter of the cylindrical cavity 17 is greater than an outer diameter of the rotating core 20, and a diameter of the cylindrical shaft 19 is less than a diameter of the central through hole of the rotating core 20.

The device further includes soft conforming pad 3. The soft conforming pad 3 includes an arc-shaped plate structure. The tensioner 10 and the soft conforming pad 3 form an integrated structure. An outer curved surface of the soft conforming pad 3 conforms to an inner curved surface of the tensioner 10. The tensioner 10 is wrapped by the soft conforming pad 3. The soft conforming pad 3 extends axially and conforms to the cattle's back, and it is dustproof and waterproof.

Two ends of the tensioner 10 are respectively provided with through holes 11. The fixed end 2 of the flexible loop band 13 passes through the through hole 11 at one end of the tensioner 10 to enter the tensioner 10, and is fixed inside the tensioner 10.

The movable end 12 of the flexible loop band 13 passes through the through hole 11 at the other end of the tensioner 10 to enter the tensioner 10, winds around the outer circumferential surface of the rotating core 20, and is fixedly embedded into the loop band clamping slot 22. The movable end 12 retracts or extends as the rotating core 20 rotates. The rotating core 20 is connected to the tensioner 10 via the spiral spring 23 of appropriate hardness. As the cattle's chest circumference grows, the flexible loop band 13 extends. The rotating core 20 rotates clockwise, storing energy in the spiral spring 23, which generates a counteracting tension force, ensuring the soft conforming pad 3 tightly conforms to the cattle's back. The curvature of the conforming part mimics the contour curve of the cattle's back, resembling the physiological contour line of the cattle, thereby reducing discomfort caused by long-term pressure on the back skin.

The spiral spring 23 of the self-adaptive tensioning module 1 is a constant-force coil spring, where the stress generated during normal deformation remains substantially constant, and the spring hardness ensures secure tensioning without harming the skin.

The fixed end 2 and the movable end 12 of the flexible loop band 13 are respectively provided with fixing buckles. The fixed end 2 of the flexible loop band 13 is buckled onto fixed post 24 inside the tensioner 10 via the fixing buckle. The movable end 12 of the flexible loop band 13 is embedded into the loop band clamping slot 22 via the fixing buckle.

As shown in FIG. 2, the monitoring module includes connection module 5 and patch 4. Two ends of the connection module 5 are respectively provided with loop band through holes 9. The flexible loop band 13 passes through the loop band through holes 9. Surfaces of the flexible loop band 13 at two sides of the connection module 5 are provided with limit protrusions 14, respectively. The patch 4 is fixed to an end face of the connection module 5 close to the cattle's chest. A surface of the patch 4 is provided with bionic octopus sucker array 8. The bionic octopus sucker array 8 is made of two-component silicone rubber of moderate hardness, possessing certain flexibility and shape retention. Compared to a flat surface, the physical adhesion generated by the bionic octopus sucker array 8 allows for tighter attachment to the monitoring site and more accurate monitoring results. The bionic octopus sucker array 8 is prepared using a special mold. Under the tension force generated by the tensioner 10, the bionic octopus sucker array is pressed against the skin surface, expelling air from the cavities of the suckers. The negative pressure effect enhances stable adhesion and friction with the skin, preventing phenomena like the monitoring site floating or detaching from the skin surface due to disturbances caused by significant cattle movements or other behaviors during cattle electrodermal monitoring.

The connection module 5 cooperating with the flexible loop band 13 is encapsulated in a lightweight hard shell. As the cattle's chest circumference increases, the flexible loop band 13 is stretched. The sliding cooperation area between the flexible loop band 13 and the connection module 5 is provided with the limit protrusions 14. The limit protrusions 14 slightly protrude from the plane of the flexible loop band 13, preventing the connection module 5 from exceeding the optimal range of sliding adjustment.

As shown in FIG. 3, the surface of the patch 4 is provided with a circular groove, and the wireless sensing module 6 is provided in the circular groove.

The wireless sensing module 6 includes sensing chip layer 7, antenna layer 15, power layer 16, and flexible printed circuit (FPC) 25. The wireless sensing module 6 sequentially includes the sensing chip layer 7, the power layer 16, and the antenna layer 15. The antenna layer 15 is attached to a bottom surface of the circular groove. The FPC 25 is connected to the sensing chip layer 7 and the antenna layer 15. The patch 4 is attached to a skin area at the cattle's chest. The attached bionic sucker array 8 generates physical adhesion under tension, holding the patch 4 firmly against the skin surface. The sensing chip layer 7 is in close contact with the skin at the cattle's chest. The wireless sensing module 6 monitors the cattle's electrodermal responses at a certain frequency and transmits them wirelessly to a host computer, achieving the electrodermal monitoring function. As the cattle grows and its chest circumference gradually expands, the reserved loop band of the movable end 12 wound on the rotating core 20 is gradually pulled out to achieve self-adaptation to the chest circumference. The patch 4 is disposed on one side of the loop band fixed end 2. Its position is relatively stable, minimally affected by the overall increase in the loop band length, which is conducive to stable electrodermal monitoring.

During daily cattle activities such as movement, the patch 4 is slidably connected to the flexible loop band 13. The sliding of the patch 4 on the loop band buffers disturbances along the loop band direction, maintaining stable contact between the sensing chip layer 7 and the skin.

The electrodermal response is the fluctuation in skin electrical resistance caused by sweat gland activity or changes in the sympathetic nervous system. When livestock such as cattle experience sensory stimulation or emotional changes, the blood vessels within their skin undergo constriction and dilation. Meanwhile, sweat gland secretion also changes, leading to variations in skin electrical resistance, resulting in the electrodermal response. In this embodiment, the wireless sensing module 6 is an electronic device for electrodermal response monitoring, applied to cattle among livestock. The wireless sensing module 6 monitors the cattle's electrodermal responses at a certain frequency and transmits them wirelessly to the host computer and cloud. The data monitoring enables timely detection of abnormalities in the physiological, i.e. electrodermal data of poultry and livestock. This is of great significance for reducing medication usage on farms, preventing large-scale disease outbreaks, and tracing health indicator data throughout the production chain of poultry and livestock products.

Overall, the present disclosure employs a more accurate monitoring method involving direct contact with the skin of poultry and livestock, utilizes a specially designed wearable structure, and innovatively designs a tensioning structure adaptive to chest circumference and a stable patch-type structure. In this way, the present disclosure solves the difficulties in applying current wearable monitoring technologies in the farming field.

What is claimed is:

1. A self-adaptive tensioning wearable monitoring device for poultry and livestock, comprising:
a self-adaptive tensioning module, a wireless sensing module, a flexible loop band, and a monitoring module, wherein the flexible loop band is threaded through the self-adaptive tensioning module and the monitoring module, and is connected end-to-end inside the self-adaptive tensioning module; a surface of the monitoring module is provided with the wireless sensing module; the monitoring module is slidably connected to the flexible loop band; the self-adaptive tensioning module comprises a first end fixedly connected to a fixed end of the flexible loop band and a second end telescopically connected to a movable end of the flexible loop band; the self-adaptive tensioning module is disposed at a poultry/livestock back; and when the flexible loop band is tightened, the wireless sensing module at the surface of the monitoring module is in tight contact with a skin in a poultry/livestock body temperature measurement area.

2. The self-adaptive tensioning wearable monitoring device for the poultry and livestock according to claim 1, wherein the self-adaptive tensioning module comprises a tensioner, a rotating core, and a spiral spring; the tensioner is internally provided with a first cylindrical cavity; the first cylindrical cavity is provided with a cylindrical shaft along an axial direction; two end faces of the cylindrical shaft abut against an inner wall of the tensioner; the cylindrical shaft comprises a first end provided with the spiral spring and a second end passing through a central through hole of the rotating core sleeved on the cylindrical shaft; an outer circumferential surface of the rotating core is provided with a first clamping slot and a loop band clamping slot; the cylindrical shaft is provided with a second cylindrical cavity along a vertical direction; and the spiral spring comprises an inner end fixed inside the second cylindrical cavity and an outer end fixed in the first clamping slot in the outer circumferential surface of the rotating core; and
two ends of the tensioner are respectively provided with through holes; the fixed end of the flexible loop band passes through the through hole at a first end of the tensioner to enter the tensioner, and is fixed inside the tensioner; and the movable end of the flexible loop band passes through the through hole at a second end of the tensioner to enter the tensioner, winds around the outer circumferential surface of the rotating core, and is fixedly embedded into the loop band clamping slot.

3. The self-adaptive tensioning wearable monitoring device for the poultry and livestock according to claim 2, wherein the fixed end and the movable end of the flexible loop band are respectively provided with fixing buckles; the fixed end of the flexible loop band is buckled onto a fixed post inside the tensioner via the fixing buckle; and the movable end of the flexible loop band is embedded into the loop band clamping slot via the fixing buckle.

4. The self-adaptive tensioning wearable monitoring device for the poultry and livestock according to claim 2, wherein a diameter of the first cylindrical cavity is greater than an outer diameter of the rotating core, and a diameter of the cylindrical shaft is less than a diameter of the central through hole of the rotating core.

5. The self-adaptive tensioning wearable monitoring device for the poultry and livestock according to claim 1, wherein the monitoring module comprises a connection module and a patch; two ends of the connection module are respectively provided with loop band through holes; the flexible loop band passes through the loop band through holes; surfaces of the flexible loop band at two sides of the connection module are provided with limit protrusions, respectively; the patch is fixed to an end face of the connection module adjacent to the skin in the poultry/livestock body temperature measurement area; a surface of the patch is provided with a bionic octopus sucker array; and the surface of the patch is provided with a circular groove for holding the wireless sensing module.

6. The self-adaptive tensioning wearable monitoring device for the poultry and livestock according to claim 3, wherein the wireless sensing module comprises a sensing chip layer, an antenna layer, a power layer, and a flexible printed circuit (FPC); the wireless sensing module sequentially comprises the sensing chip layer, the power layer, and the antenna layer; the antenna layer is attached to a bottom surface of a circular groove; the FPC is connected to the sensing chip layer and the antenna layer; and the sensing chip layer is in tight contact with the skin in the poultry/livestock body temperature measurement area.

7. The self-adaptive tensioning wearable monitoring device for the poultry and livestock according to claim 1, further comprising a soft conforming pad, wherein the soft conforming pad comprises an arc-shaped plate structure; an outer curved surface of the soft conforming pad conforms to an inner curved surface of the tensioner; and the soft conforming pad extends axially and conforms to the poultry/livestock back.

8. The self-adaptive tensioning wearable monitoring device for the poultry and livestock according to claim 5, wherein the bionic octopus sucker array is made of silicone rubber, and when the flexible loop band is tightened, a compressive force is applied to the bionic octopus sucker array to cause deformation.

9. The self-adaptive tensioning wearable monitoring device for the poultry and livestock according to claim 8, wherein the bionic octopus sucker array comprises cylindrical concave cavities formed by a combination of a cylindrical hole array mold and a metal ball.
